(19) United States
(12) Patent Application Publication
(10) Pub. No.: US 2020/0001964 A1
(43) Pub. Date: Jan. 2, 2020

(54) SYSTEM AND METHOD FOR CONVERTING A PASSENGER AIRCRAFT TO A CARGO AIRCRAFT

(71) Applicant: Precision Conversions, LLC, Beaverton, OR (US)

(72) Inventor: William J. Wagner, Valley Center, CA (US)

(21) Appl. No.: 15/849,149

(22) Filed: Dec. 20, 2017

Related U.S. Application Data
(63) Continuation of application No. 14/618,817, filed on Feb. 10, 2015, now abandoned.
Application No. 14/618,817 is a continuation of application No. 14/085,328, filed on Nov. 20, 2013, now abandoned.
Application No. 14/085,328 is a continuation of application No. 13/773,918, filed on Feb. 22, 2013, now abandoned.
Application No. 13/773,918 is a continuation of application No. 13/010,468, filed on Jan. 20, 2011, now abandoned.
Application No. 13/010,468 is a continuation of application No. 12/407,654, filed on Mar. 19, 2009, now abandoned.
Application No. 12/407,654 is a continuation of application No. 11/473,599, filed on Jun. 22, 2006, now abandoned.
(60) Provisional application No. 60/693,227, filed on Jun. 22, 2005.
(60) Provisional application No. 60/693,226, filed on Jun. 22, 2005.

(51) Int. Cl. B64C 1/14

(52) U.S. Cl. CPC B64C 1/1415; Y10T 29/49716

(57) ABSTRACT

An aircraft-conversion method of converting a passenger aircraft to a cargo aircraft, includes selecting a passenger aircraft, and converting the aircraft to a cargo aircraft by changing a door of the aircraft to accommodate loading and unloading of cargo. The selecting step may involve an all-passenger aircraft, and the converting step may include removing all seats from the aircraft. A system for converting a passenger aircraft with a passenger door for passenger entry and exit to a cargo aircraft includes aircraft-door conversion structure constructed to replace the passenger door with a cargo door that allows loading and unloading of cargo on the aircraft via the cargo door. A converted cargo aircraft includes an aircraft body, and aircraft-door conversion structure constructed to replace the passenger door with a cargo door that allows loading and unloading of cargo on the aircraft via the cargo door.

### CROSS-REFERENCE TO RELATED APPLICATIONS

This application is a continuation of U.S. patent application Ser. No. 14/618,817, filed Feb. 10, 2015, which application is a continuation of U.S. patent application Ser. No. 14/085,328, filed Nov. 20, 2013, which application is a continuation of U.S. patent application Ser. No. 13/773,918, filed Feb. 22, 2013, which application is a continuation of U.S. patent application Ser. No. 13/010,468, filed Jan. 20, 2011, which application is a continuation of U.S. patent application Ser. No. 12/407,654, filed Mar. 19, 2009, which application is a continuation of U.S. patent application Ser. No. 11/473,599, filed Jun. 22, 2006, which application claims priority to U.S. Provisional Patent Application Ser. No. 60/693,227, filed Jun. 22, 2005, and also claims priority to U.S. Provisional Patent Application Ser. No. 60/693,226, filed Jun. 22, 2005, all entitled “System and Method for Converting a Passenger Aircraft to a Cargo Aircraft”, and all of which are incorporated herein by reference.

### SUMMARY OF INVENTION

One feature of the invention is an aircraft-conversion method of converting a passenger aircraft to a cargo aircraft, and that method includes selecting a passenger aircraft, and converting the aircraft to a cargo aircraft by changing a door of the aircraft to accommodate loading and unloading of cargo. The selecting step may involve an all-passenger aircraft, and the converting step may include removing all seats from the aircraft.

Another feature of the invention is a system for converting a passenger aircraft with a passenger door for passenger entry and exit to a cargo aircraft includes aircraft-door conversion structure constructed to replace the passenger door with a cargo door that allows loading and unloading of cargo on the aircraft via the cargo door.

Another feature of the invention is a converted cargo aircraft includes an aircraft body, and aircraft-door conversion structure constructed to replace the passenger door with a cargo door that allows loading and unloading of cargo on the aircraft via the cargo door.

### DETAILED DESCRIPTION OF THE PREFERRED EMBODIMENT

Referring to Attachment A, there is a detailed description of the invention including the preferred embodiment.

I claim:

1. An aircraft-conversion method of converting a passenger aircraft to a cargo aircraft, comprising:
selecting a passenger aircraft; and
converting the aircraft to a cargo aircraft by changing a door of the aircraft to accommodate loading and unloading of cargo.

2. The method of claim 1, wherein the selecting step involves an all-passenger aircraft.

3. The method of claim 1, wherein the converting step includes removing all seats from the aircraft.

4. A system for converting a passenger aircraft with a passenger door for passenger entry and exit to a cargo aircraft, comprising:
aircraft-door conversion structure constructed to replace the passenger door with a cargo door that allows loading and unloading of cargo on the aircraft via the cargo door.

5. A converted cargo aircraft, comprising:
an aircraft body;
aircraft-door conversion structure constructed to replace the passenger door with a cargo door that allows loading and unloading of cargo on the aircraft via the cargo door.
